(19) United States
(12) Patent Application Publication
(10) Pub. No.: US 2005/0132174 A1
(43) Pub. Date: Jun. 16, 2005

(54) Predicting instruction branches with independent checking predictions

(75) Inventors: Stephan J. Jourdan, Portland, OR (US); Boyd S. Phelps, Hillsboro, OR (US); Mark C. Davis, Portland, OR (US)

Correspondence Address: KENYON & KENYON, 1500 K STREET, N.W., SUITE 700, WASHINGTON, DC, 20005, US

(73) Assignee: INTEL CORPORATION

(21) Appl. No.: 10/735,675

(22) Filed: Dec. 16, 2003

(51) Int. Cl. G06F 9/00

(52) U.S. Cl. 712/239

(57) ABSTRACT

Systems and methods of predicting instruction branches provide for independent checking predictions and dynamic next-line predictions. Next-line predictions may also have a latency that is a plurality of clock cycles, where the next line predictions include group predictions. Each group prediction includes a plurality of target addresses corresponding to their plurality of clock cycles. The plurality of target addresses can include a leaf target and one or more intermediate targets, where the leaf target defines a target address of the group prediction.

### BACKGROUND

1. Technical Field

Embodiments of the present invention generally relate to computers. More particularly, embodiments relate to branch prediction and computer processing architectures.

2. Discussion

In the computer industry, the demand for higher processing speeds is well documented. While such a trend is highly desirable to consumers, it presents a number of challenges to industry participants. A particular area of concern is branch prediction.

Modern day computer processors are organized into one or more “pipelines,” where a pipeline is a sequence of functional units (or “stages”) that processes instructions in several steps. Each functional unit takes inputs and produces outputs, which are stored in an output buffer associated with the stage. One stage's output buffer is typically the next stage's input buffer. Such an arrangement allows all of the stages to work in parallel and therefore yields greater throughput than if each instruction had to pass through the entire pipeline before the next instruction could enter the pipeline. Unfortunately, it is not always apparent which instruction should be fed into the pipeline next, because many instructions have conditional branches.

When a computer processor encounters instructions that have conditional branches, branch prediction is used to eliminate the need to wait for the outcome of the conditional branch instruction and therefore keep the processor pipeline as full as possible. Thus, a branch prediction architecture predicts whether the branch will be taken and retrieves the predicted instruction rather than waiting for the current instruction to be executed. Indeed, it has been determined that branch prediction is one of the most important contributors to processor performance.

In one approach, a relatively simple predictor is used to generate a current next-line prediction based on a previous next-line prediction, where a more complex predictor is used to generate a current checking prediction based on the previous next-line prediction. The term “next-line” refers to the cache line that contains the next instruction to be retrieved. In the case of a trace cache, which stores sequences of micro-operations (or μops) that have already been decoded from instructions, the next-line prediction will identify the line in the trace cache that contains the next sequence of μops. In the case of an instruction cache, which stores instructions that have not yet been decoded, the next-line prediction will identify the line in the instruction cache that contains the next instruction.

A relatively simple predictor is typically used to generate the current next-line prediction in order to keep the next-line prediction to one prediction per cycle. For example, the simple predictor is often a static predictor, which presumes sequential operation by always predicting that the branch is not taken. Even in cases where a dynamic predictor is used to generate the next-line prediction, the dynamic predictor is generally limited to bimodal operation, which fails to take into consideration valuable information regarding global branch history, indirect branching and return branching. If the complexity of the next-line predictor is such that each next-line prediction takes more than one clock cycle, on the other hand, throughput (or bandwidth) can be negatively affected. Accordingly, conventional next-line predictions often have considerable room for improvement with regard to performance.

It should also be noted that in conventional computing architectures, subsequent checking predictions are typically generated based on current checking predictions. The checking predictions are therefore dependent upon one another. The longer latency of the more complex predictors can cause checking predictions to result in undesirable pipeline delays in the event that the checking predictions disagree with the next-line predictions. There is therefore a need for an approach to predicting instruction branches that permits more robust next-line predictions without running afoul to the need for at least one prediction per cycle. There is also a need for an approach that does not result in the latency problems commonly associated with interdependent checking predictions.

### BRIEF DESCRIPTION OF THE DRAWINGS

The various advantages of embodiments of the present invention will become apparent to one skilled in the art by reading the following specification and appended claims, and by referencing the following drawings, in which:

FIG. 1 is a timing diagram of an example of a series of branch predictions according to one embodiment of the invention;

FIG. 2 is a block diagram of an example of a branch prediction architecture according to one embodiment of the invention;

FIG. 3 is a flowchart of an example of a method of predicting instruction branches according to one embodiment of the invention;

FIG. 4 is a flowchart of an example of a process of comparing a current checking prediction to a current next-line prediction according to one embodiment of the invention;

FIG. 5 is a timing diagram of an example of a series of branch predictions according to an alternate embodiment of the invention;

FIG. 6 is a flowchart of an example of a process of generating a current next-line prediction according to one embodiment of the invention;

FIG. 7 is a diagram of a next-line predictor according to one embodiment of the invention;

FIG. 8 is a block diagram of an next-line predictor according to one embodiment of the invention; and

FIG. 9 is a block diagram of a computer system, according to one embodiment of the invention.

### DETAILED DESCRIPTION

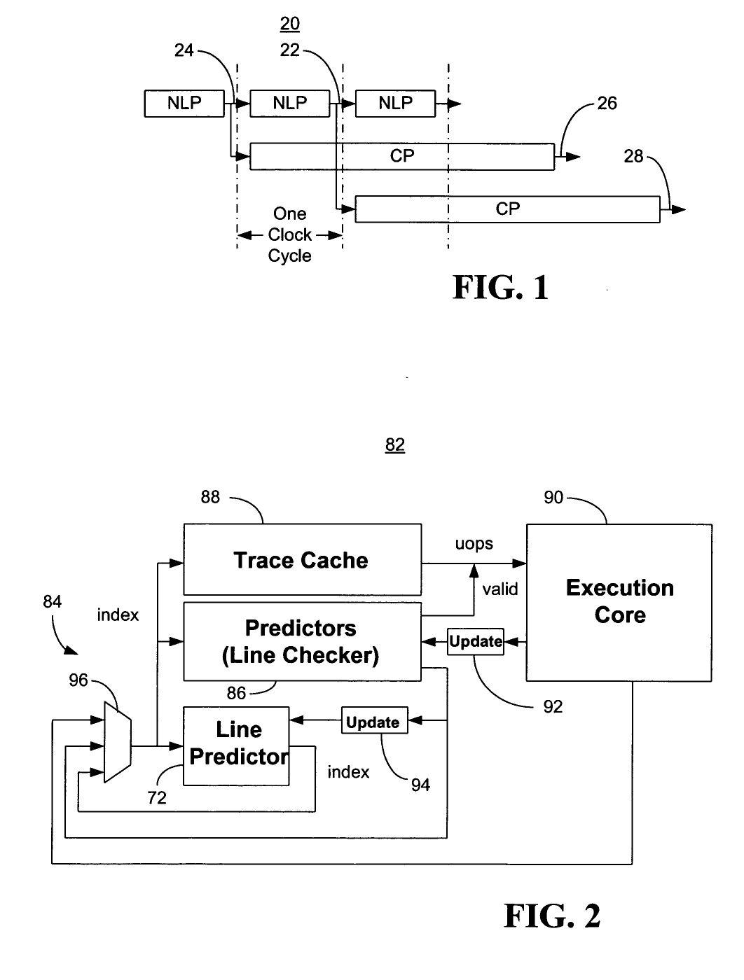

Systems and methods of predicting instruction branches provide for robust next-line predictions at a rate of at least one prediction per cycle, and checking predictions that are not interdependent. As a result, a number of performance advantages can be achieved. FIG. 1 shows a timing diagram 20 in which a current next-line prediction 22 is generated based on a previous next-line prediction 24, and a current checking prediction 26 is generated based on the previous next-line prediction 24. As will be discussed in greater detail, the current checking prediction 26 is compared to the current next-line prediction 22 to determine the accuracy of the next-line predictions. A subsequent checking prediction 28 is generated based on the current next-line prediction 22, where the current predictions 26, 28 are independent from one another and can have a longer latency than the next-line predictions 22, 24. In the illustrated example, the next-line predictions 22, 24 have a latency of approximately one clock cycle, where the checking predictions 26, 28 have a latency of approximately three clock cycles. The longer latency of the checking predictions 26, 28 is due to the more complex prediction algorithms associated with the checking predictions 26, 28. Indeed, the checking predictions could have a much longer latency than the three-cycle latency illustrated.

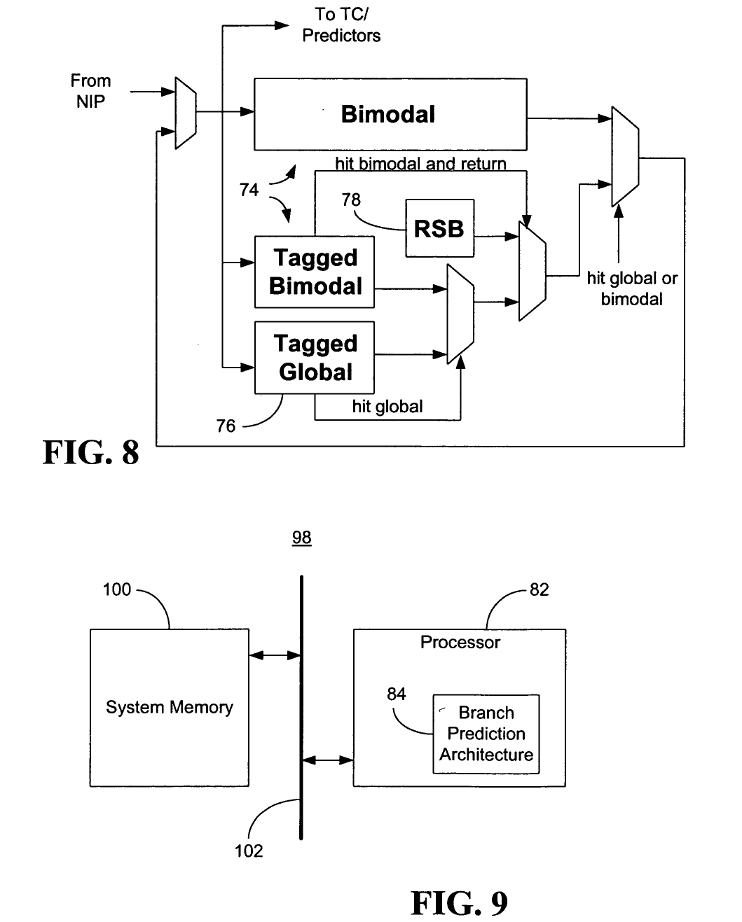

Turning now to FIG. 2, a portion of a processor 82 is shown. Generally, a branch prediction architecture 84 includes the next-line predictor 72 and one or more checking predictors 86. Processor 82 also includes a trace cache 88 and an execution core 90. A checking update module 92 updates the checking predictor 86 based on execution results, and a next-line update module 94 updates the next-line predictor 72 based on input from the checking predictor 86. A multiplexer 96 selects between clear signals from the execution core 90, clear signals from the checking predictor 86 and index values from the next-line predictor 72. FIG. 8 shows the components of the next-line predictor 72 as they relate to one another.

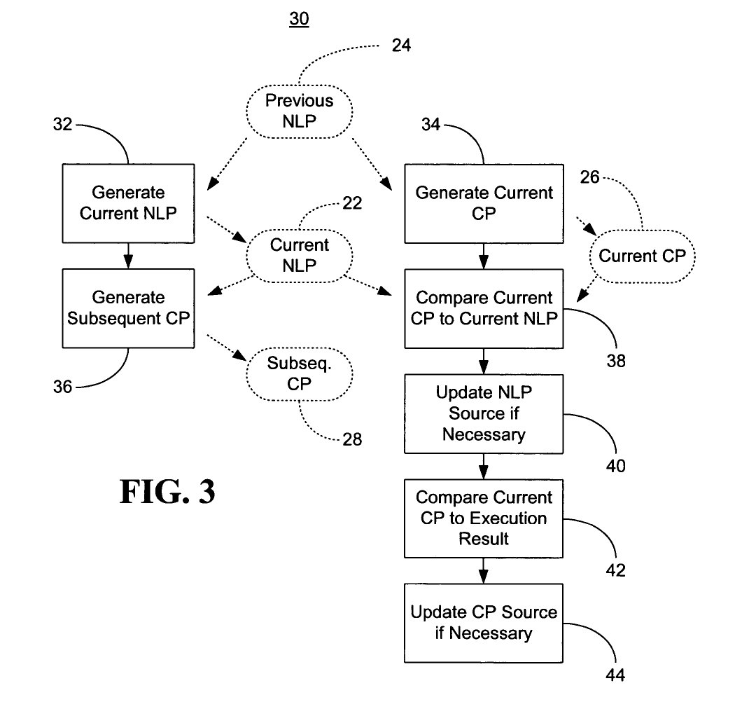

Turning now to FIG. 3, a method 30 is shown in which a processing block 32 provides for generating the current next-line prediction 22 based on the previous next-line prediction 24. Block 34 provides for generating the current checking prediction 26 based on the previous next-line prediction 24. The subsequent checking prediction 28 is generated at block 36 based on the current next-line prediction 22. As already discussed, the checking predictions 26, 28 are independent from one another and can have a longer latency than the next-line predictions 22, 24. Block 38 provides for comparing the current checking prediction 26 to the current next-line prediction 22. Block 40 provides for updating the source of the next-line predictions 22, 24 (namely, the next-line predictor) based on the current checking prediction 26 if the current next-line prediction 22 does not have a target address that corresponds to a target address of the current checking prediction 26. Block 42 provides for comparing the current checking prediction 26 to an execution result, where the source of the current checking prediction 26 is updated at block 44 based on the execution result if the target address of the current checking prediction does not correspond to a target address of the execution result.

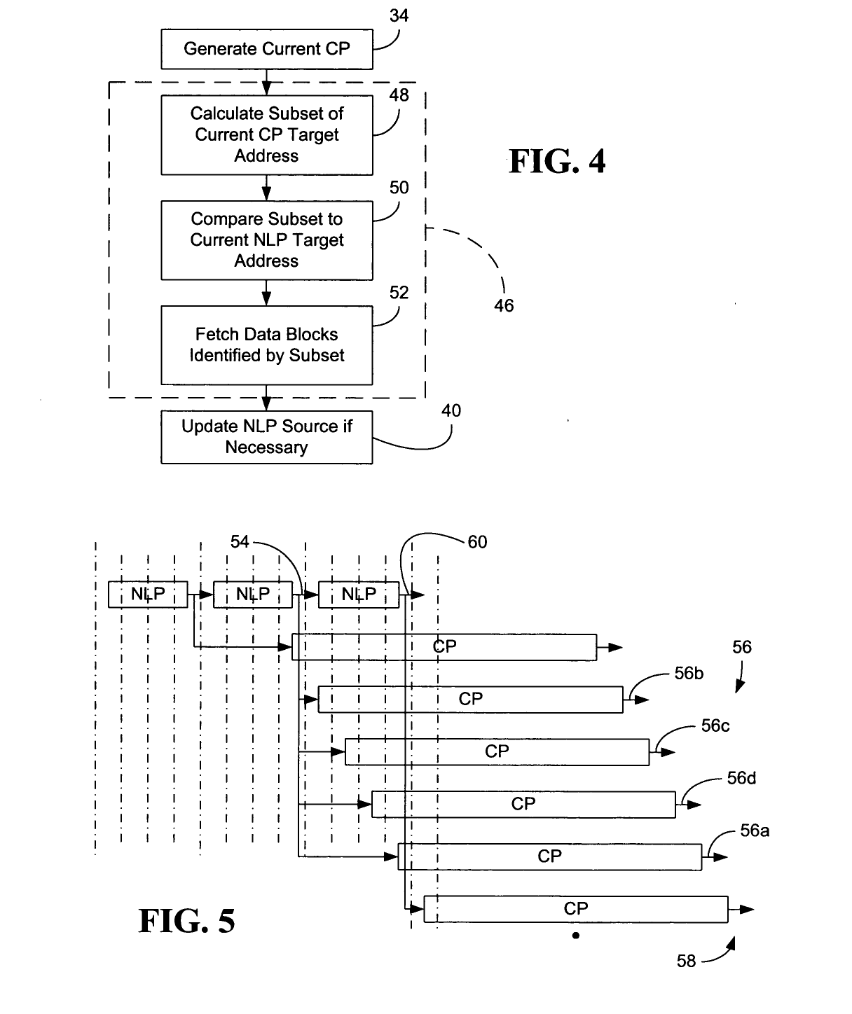

FIG. 4 shows one approach to comparing the current checking prediction to the current next-line prediction in greater detail at block 46. Accordingly, block 46 can be readily substituted for block 38 (FIG. 3) already discussed. Specifically, a subset of the target address of the current checking prediction is calculated at block 48. The subset is compared to the target address of the current next-line prediction at block 50, and one or more data blocks identified by the subset of the target address of the current checking prediction are fetched at block 52. Using a subset of the address minimizes the latency associated with the checking predictions.

It should be noted that the next-line predictions may predict that a branch is either taken or not taken, and are therefore dynamic. In this regard, the latencies associated with the next-line predictions may be more than one clock cycle. FIG. 5 shows an example in which the next-line predictions have a latency that is approximately four clock cycles. In such a case, a previous next-line prediction 54 includes a previous group prediction, where the previous group prediction includes a plurality of target addresses corresponding to the plurality of clock cycles. Thus, in the illustrated example, the previous group would include four target addresses. The plurality of target addresses includes a leaf target and one or more intermediate targets, where the leaf target defines a target address of the group prediction. A plurality of current checking predictions 56 is generated based on the plurality of target addresses, where each of the plurality of current checking predictions 56 is independent from one another. Similarly, a plurality of subsequent checking predictions 58 is generated based on the current next-line prediction 60, where the plurality of current checking predictions 56 is independent from the plurality of subsequent checking predictions 58, and each of the plurality of subsequent checking predictions 58 is independent from one another.

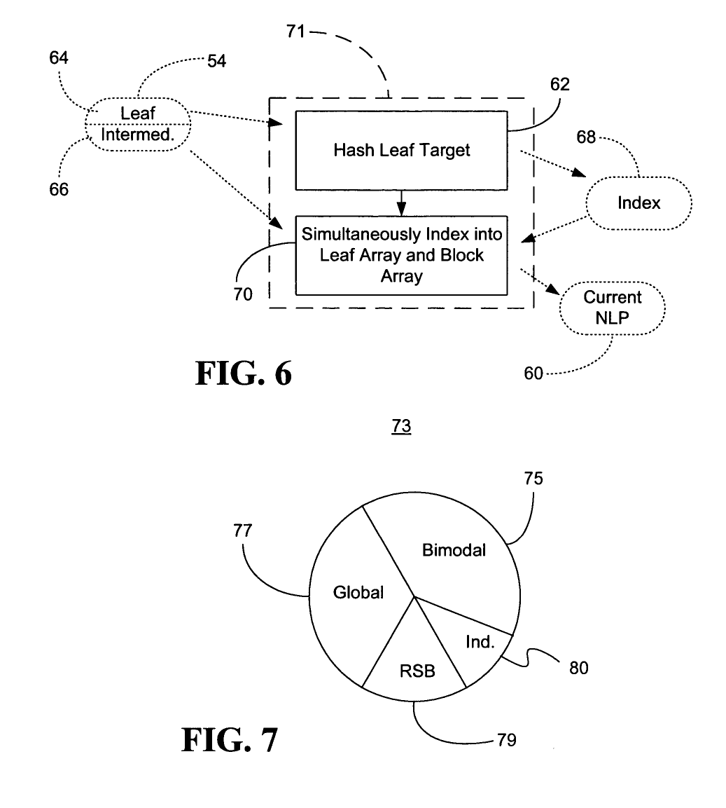

FIG. 6 shows one approach to generating a current next-line prediction at block 71 for the case in which the next-line predictions have a latency that is a plurality of clock cycles. Such a condition could negatively affect throughput under conventional approaches. Block 71, on the other hand, obviates many throughput concerns. Furthermore, block 71 can be readily substituted for processing block 32 (FIG. 3) already discussed. As also already discussed, the previous next-line prediction 54 includes a previous group prediction, where the previous group prediction includes a plurality of target addresses. The plurality of target addresses includes a leaf target 64 and one or more intermediate targets 66, where the leaf target 64 defines the target address of the group prediction. Essentially, a group prediction is a set of four data block predictions, where each data block prediction includes an exit point, a target address and additional information. For example, the group prediction could we written as (E01, A1), (E1, A2), (E2, A3), (E3, A4), where (E0, A0) is a data block. The leaf target therefore enables a new group prediction. The group prediction is stored in a next-line prediction table at an index described below. Processing block 62 provides for hashing the leaf target 64 to obtain an index 68. Processing block 70 provides for simultaneously indexing into a leaf array based on the index 68 and into a block array based on the intermediate targets 66 to obtain the current next-line prediction 60, where the leaf array and the block array define the next-line prediction table.

It should be noted that by generating group predictions, the number of predictions per cycle can be tailored to a desired level. For example, if throughput constraints require one prediction per cycle and each next-line prediction takes four cycles, designing the group predictions to include four predictions would result in one prediction per cycle. On the other hand, if one prediction is require for only every two cycles, the number of predictions in a group could be reduced to two. Other throughput constraints and group sizes can be readily used without parting from the spirit and scope of the embodiments of the invention.

FIGS. 7 and 8 show a next-line predictor 72 that has a bimodal component 74, a global component 76, a return stack buffer (RSB) component 78 and an indirect branch component 80. The bimodal component 74 generates bimodal predictions 75 based on previous next-line predictions and the global component 76 generates global predictions 77 based on the previous next-line predictions. The global component 76 also generates indirect predictions 80 based on indirect branch values. The RSB component 78 generates return predictions 79 based on a return stack buffer value. The next-line predictor 72 selects from the bimodal predictions, the global predictions, the return predictions and the indirect predictions to obtain current next-line predictions. Thus, the set of predictions 73 generated by the next-line predictor 72 closely approximate the predictions of a more complex checking predictor. The content and distribution of predictions 73 is shown to facilitate discussion only and may vary depending upon the circumstances.

With regard to the bimodal component 74 and the global component 76, a bimodal table, which is indexed with address bits only, and a global table provide a very efficient structure for branch prediction. Such a “BG” structure can be used to generate group predictions as well. Accordingly, the next-line prediction table can be split into a bimodal table and a tagged global table. The block and leaf arrays are split accordingly. It should be noted that it is not necessary to physically replicate the tags in the global portions of the block and leaf arrays. In other words, a single copy of the tags and the global leaf array may be sufficient. The bimodal table can be accessed with an index resulting from applying a hashing function, H, on the leaf target. Such a function can be represented by the expression H(LIP)=LIP ⊕ (LIP>>7). The global table can be accessed by applying a hashing function Hg on the leaf target and the history of past branches. The tags in the global table can be obtained by taking a few bits from the bimodal table indices. Taking the six least-significant bits of the bimodal table indices for the targets is one approach. Indexing can also be implemented without the use of hashing functions. In such a case, the lower bits of the instruction address can be used. As already discussed, the tables are accessed simultaneously. If there is a tag match in the global table, the group prediction is taken from the global table. Otherwise, the group prediction is taken from the bimodal table.

With regard to the RSB component 78. A small eight-entry return stack per active thread can be assumed. Other stack sizes may also be used. Each time a call instruction is encountered, the return target address is computed (i.e., the next linear instruction pointer/NLIP of the call) and is pushed onto the return stack. Whenever a return is encountered, a prediction is obtained by reading the top of stack (TOS) and removing the target address. Such a prediction overrides the prediction delivered by the BG predictor. It should be noted, however, that blocks ending on a call or a return must be identified. Accordingly, a “call” bit is added to every entry of the leaf array to identify calls. For returns, a “return” bit may be added, but such an approach requires a three-input multiplexer (MUX) at the output of the leaf array rather than a two-input MUX. If such an approach impairs the critical path, the two-input MUX may be used by trading off some prediction accuracy.

Since the global leaf array is much smaller than the bimodal leaf array, its access time is relatively short. Accordingly, the global prediction will be known before the bimodal prediction. By using the return bit stored in the global array (assuming there is a hit in the global array), a selection can be made between the stack and global array predictions at the same time tag matching is being performed. Due to prediction update, every return that is mispredicted with the bimodal table will record an entry in the global table.

Turning now to FIG. 9, a computer system 98 is shown. Computer system 98 includes a system memory 100 such as random access memory (RAM), read only memory (ROM), flash memory, etc., that stores a branch instruction having an instruction address. A system bus 102 is coupled to the system memory 100 and the processor 82. The processor 82 has a branch prediction architecture 84 with a next-line predictor (not shown) and a checking predictor (not shown) as already discussed. The next-line predictor generates a current next-line prediction based on the instruction address. The checking predictor generates a current checking predictor based on the instruction address, and generates a subsequent checking prediction based on the current-line prediction. The checking predictions are independent from one another and can have a longer latency than the current next-line prediction. It should be noted that although in the illustrated example the predictions are based on an address retrieved from “off chip” memory, address may also be retrieved from other memories such as trace cache, instruction cache, etc.

Those skilled in the art can appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A method of predicting instruction branches, comprising:
generating a current next-line prediction based on a previous next-line prediction; and
generating a current checking prediction based on the previous next-line prediction; and
generating a subsequent checking prediction based on the current next-line prediction, the checking predictions being independent from one another and having a longer latency than the next-line predictions.

2. The method of claim 1, further including:
comparing the current checking prediction to the current next-line prediction; and
updating a source of the next-line predictions based on the current checking prediction if the current next-line prediction does not have a target address that corresponds to a target address of the current checking prediction.

3. The method of claim 2, further including:
calculating a subset of the target address of the current checking prediction; and
comparing the subset to the target address of the current next-line prediction.

4. The method of claim 3, further including fetching one or more data blocks identified by the subset of the target address of the current checking prediction.

5. The method of claim 2, further including:
comparing the current checking prediction to an execution result; and
updating a source of the current checking prediction based on the execution result if the target address of the current checking prediction does not correspond to a target address of the execution result.

6. The method of claim 1, further including generating a subsequent next-line prediction based on the current next-line prediction.

7. The method of claim 1, wherein the next-line predictions are dynamic predictions.

8. The method of claim 1, wherein the previous next-line prediction has a latency that is a plurality of clock cycles and the previous next-line prediction includes a previous group prediction, the previous group prediction including a plurality of target addresses corresponding to the plurality of clock cycles.

9. The method of claim 8, wherein the plurality of target addresses includes a leaf target and one or more intermediate targets, the leaf target defining a target address of the group prediction.

10. The method of claim 9, further including:
hashing the leaf target to obtain an index; and
simultaneously indexing into a leaf array based on the index and into a block array based on the intermediate targets to obtain the current next-line prediction.

11. The method of claim 10, wherein the leaf array and the block array define a next-line prediction table.

12. The method of claim 8, further including generating a plurality of current checking predictions based on the plurality of target addresses, each of the plurality of current checking predictions being independent from one another.

13. The method of claim 12, further including generating a plurality of subsequent checking predictions based on the current next-line prediction, the plurality of current checking predictions being independent from the plurality of subsequent checking predictions, each of the plurality of subsequent checking predictions being independent from one another.

14. The method of claims 8, further including:
generating a bimodal prediction based on the previous next-line prediction;
generating a global prediction based on the previous next-line prediction;
generating a return prediction based on a return stack buffer value;
generating an indirect branch prediction based on an indirect branch value; and
selecting from the bimodal prediction, the global prediction, the return prediction and the indirect prediction to obtain the current next-line prediction.

15. A method of predicting instruction branches, comprising:
generating a current next-line prediction based on a previous next-line prediction, the previous next-line prediction having a latency that is a plurality of clock cycles, the previous next-line prediction including a previous group prediction, the previous group prediction including a plurality of target addresses corresponding to the plurality of clock cycles, the plurality of target addresses including a leaf target and one or more intermediate targets, the leaf target defining a target address of the previous prediction;
generating a plurality of current checking predictions based on the plurality of target addresses, each of the plurality of current checking predictions being independent from one another;
generating a plurality of subsequent checking predictions based on the current next-line prediction, the plurality of subsequent checking predictions being independent from the plurality of current checking predictions, each of the plurality of subsequent checking predictions being independent from one another, the next-line predictions being dynamic predictions.

16. The method of claim 15, further including:
hashing the leaf target to obtain an index; and
simultaneously indexing into a leaf array based on the index and into a block array based on the intermediate targets to obtain the current next-time predictions.

17. The method of claim 16, wherein the leaf array and the block array define a next-line predictor table.

18. A branch prediction architecture comprising:
a next-line predictor to generate a current next-line prediction based on a previous next-line prediction; and
a checking predictor to generate a current checking prediction based on the previous next-line prediction, and to generate a subsequent checking prediction based on the current next-line prediction, the checking predictions to be independent from one another and to have a longer latency than the next-line predictions.

19. The architecture of claim 18, further including a front end comparator to compare the current checking prediction to the current next-line prediction, and to update the next-line predictor based on the current checking prediction if the current next-line prediction does not have a target address that corresponds to a target address of the current checking prediction.

20. The architecture of claim 19, wherein the checking predictor is to calculate a subset of the target address of the current checking prediction, and to compare the subset to the target address of the current next-line prediction.

21. The architecture of claim 20, further including an instruction fetching unit to fetch one or more data blocks identified by the subset of the target address of the current checking prediction.

22. The architecture of claim 19, further including an execution comparator to compare the current checking prediction to an execution result, and to update the checking predictor based on the execution result if the target address of the current checking prediction does not correspond to a target address of the execution result.

23. The architecture of claim 18, wherein the next-line predictions are dynamic predictions.

24. The architecture of claim 18, wherein the previous next-line prediction is to have a latency that is a plurality of clock cycles and the previous next-line prediction is to include a previous group prediction, the previous group prediction to include a plurality of target addresses corresponding to the plurality of clock cycles.

25. The architecture of claim 24, wherein the plurality of target addresses is to include a leaf target and one or more intermediate targets, the leaf target to define a target address of the group prediction.

26. A computer system comprising:
a random access memory to store a branch instruction having an instruction address;
a system bus coupled to the memory; and
a processor coupled to the system bus, the processor having a next-line predictor and a checking predictor, the next-line predictor to generate a current next-line prediction based on the instruction address, the checking predictor to generate a current checking prediction based on the instruction address, and to generate a subsequent checking prediction based on the current next-line prediction, the checking predictions to be independent from one another and to have a longer latency than the current next-line prediction.

27. The computer system of claim 26, further including a front end comparator to compare the current checking prediction to the current next-line prediction, and to update the next-line predictor based on the current checking prediction if the current next-line prediction does not have a target address that corresponds to a target address of the current checking prediction.

28. The computer system of claim 27, wherein the checking predictor is to calculate a subset of the target address of the current checking prediction, and to compare the subset to the target address of the current next-line prediction.

29. The computer system of claim 26, wherein the next-line prediction is dynamic.
